(19) United States
(12) Patent Application Publication
(10) Pub. No.: US 2025/0077893 A1
(43) Pub. Date: Mar. 6, 2025

(54) META TEMPORAL POINT PROCESSES

(71) Applicant: Royal Bank of Canada, Toronto (CA)

(72) Inventors: Wonho BAE, Vancouver (CA); Frederick TUNG, Vancouver (CA); Mohamed Osama AHMED, Vancouver (CA); Gabriel OLIVEIRA, Vancouver (CA)

(21) Appl. No.: 18/460,478

(22) Filed: Sep. 1, 2023

(51) Int. Cl. G06N 3/0985; G06N 3/0455

(52) U.S. Cl. CPC G06N 3/0985; G06N 3/0455

(57) ABSTRACT

Broadly speaking, the present disclosure describes a method of modeling a temporal point process (TPP). For each sequence in the TPP, the method treats the sequence as one of a plurality of distinct tasks, and applies meta learning to the distinct tasks. Applying meta learning to the distinct tasks may comprise applying a neural process to the distinct tasks; the neural process may be an attentive neural process.

### TECHNICAL FIELD

The present disclosure relates to machine learning, and more particularly to machine learning models of temporal point processes (TPPs).

### BACKGROUND

With the advancement of deep learning, there has been growing interest in modeling TPPs using neural networks. Although there have been developments in how neural temporal point processes (NTPPs) encode the history of past events (Biloš et al. 2021) or how they decode these representations into predictions of the next event (Shchur et al., 2020; Lin et al., 2022), the general training framework for TPPs has been supervised learning where a model is trained on a collection of all the available sequences. However, supervised learning is susceptible to overfitting, especially in high noise environments, and generalization to new tasks can be challenging.

NTPPs have been proposed to capture complex dynamics of stochastic processes in time. They are derived from traditional temporal point processes (Hawkes, 1971; Isham & Westcott, 1979; Daley & Vere-Jones, 2003). Models based on recurrent neural networks (RNNs) are proposed by Du et al. (2016) and Mei & Eisner (2017) to improve NTPPs by constructing continuous-time RNNs. More recent works use transformers to capture long-term dependency (Kumar et al., 2019; Zhang et al., 2020; Zuo et al., 2020; Yang et al., 2022; Zhang et al., 2022). Omi et al. (2019), Shchur et al., (2020) and Sharma et al. (2021) propose intensity-free NTPPs to directly model the conditional distribution of event times. Omi et al. (2019) propose to model a cumulative intensity with a neural network. But, this approach suffers from the problem that the probability density is not normalised and negative event times receive non-zero probabilities.

Shchur et al. suggest modelling conditional probability density by log-normal mixtures. Transformer-based models like Zhang et al. (2020) and Zuo et al. (2020) propose to leverage the self-attention mechanism to capture long-term dependencies. Another class of TPP methods called neural flows (Biloš et al., 2021) is proposed to model temporal dynamics with ordinary differential equations learned by neural networks. The log-normal mixture approach, transformer-based models and neural flows do not treat each input sequence as a distinct task.

Transformer neural process (Nguyen & Grover, 2022) also models event sequences, but it focuses on modeling regular time series: discrete and regularly-spaced time inputs with corresponding label values. TPPs are different as they are continuous and irregularly-spaced time sequences not necessarily having corresponding label values.

### SUMMARY

The present disclosure formulates the TPP problem in a meta learning framework, and presents a conditional meta TPP formulation, a latent path extension, and embodiments which incorporate attention.

Broadly speaking, the present disclosure describes a method of modeling a TPP. For each sequence in the temporal point process, the method treats the sequence as one of a plurality of distinct tasks, and applies meta learning to the distinct tasks. Applying meta learning to the distinct tasks may comprise applying a neural process to the distinct tasks; the neural process may be an attentive neural process.

In one aspect, a computer-implemented machine learning method for prediction for a temporal point process is described. The method comprises receiving, by at least one trained encoder, an event series comprising a plurality of discrete event times τ₁, τ₂ . . . τₗ and outputting, by the trained encoder(s), an encoded history of context features r₁, r₂ . . . rₗ. The encoded history is derived from the event times, and the encoded history is restricted to a local history window of size k, where the local history window excludes those of the event times that are more than k events ago. The method further comprises generating a global feature G from the encoded history. Generating the global feature G is performed using a subset r₁, r₂ . . . rₗ₋₁ of the encoded history that excludes a most recent one rₗ of the context features. The method still further comprises providing, to a trained decoder, a representation of the global feature G and the most recent one rₗ of the context features r₁, r₂ . . . rₗ and outputting by the trained decoder, a prediction for a time τₗ₊₁ of a next event. The prediction is derived from at least the representation of the global feature G and the most recent one rₗ of the context features r₁, r₂ . . . rₗ.

In one embodiment, the representation of the global feature G is the global feature G itself. In another embodiment, the representation of the global feature G is a global latent variable z for the global feature G.

In a preferred embodiment, the method further comprises applying cross-attention to the subset r₁, r₂ . . . rₗ₋₁ of the encoded history to generate an attention feature rₗ′ and providing the attention feature rₗ′ to the trained decoder. The prediction is further derived from the attention feature rₗ′. In a particularly preferred embodiment, the representation of the global feature G is a global latent variable z for the global feature G.

In some embodiments, there may be a single encoder. In other embodiments, there may be a first encoder and a second encoder, in which case the first encoder and the second encoder may be different encoders, although the first encoder and the second encoder may share at least some model parameters, or the first encoder and the second encoder may be duplicate encoders.

In some embodiments, the global feature G is a permutation-invariant operation incorporating all members of the subset r₁, r₂ . . . rₗ₋₁ of the encoded history.

The method may further comprise, prior to receiving the event series at the trained encoder, building the trained encoder(s) and building the trained decoder.

In other aspects, computer program products and data processing systems for implementing the above-described methods are also provided.

### BRIEF DESCRIPTION OF THE DRAWINGS

These and other features will become more apparent from the following description in which reference is made to the appended drawings wherein:

FIG. 1 shows a schematic representation of a general form of a neural TPP model according to an aspect of the present disclosure;

FIG. 2 shows a schematic representation of a Conditional Meta TPP model according to an aspect of the present disclosure;

FIG. 2A shows a schematic representation of a Meta TPP model according to an aspect of the present disclosure;

FIG. 3 shows a schematic representation of an Attentive TPP model according to an aspect of the present disclosure;

FIG. 3A shows a schematic representation of a modified version of the Attentive TPP model shown in FIG. 3;

FIGS. 4A through 4C show visualizations of examples of, respectively, the Sinusoidal dataset, the Uber dataset, and the NYC Taxi dataset according to an aspect of the present disclosure.

FIG. 5A is a graph showing experimental results for imputation with different drop rates for each of THP⁺, Meta TPP, and Attentive TPP;

FIG. 5B is a graph showing experimental results for distribution drift for each of THP⁺ and Meta TPP;

FIG. 6A is a graph showing qualitative analysis on cross-attention results;

FIG. 6B is visualization showing test predictions versus targets for THP and the Attentive TPP model; and

FIG. 7 is a block diagram of an illustrative computer system, which may be used to implement aspects of the present disclosure.

### DETAILED DESCRIPTION

The previous approaches described above train a model in a supervised learning framework. Unlike the conventional TPP methods described above, the present disclosure frames TPPs as meta learning rather than supervised learning.

Meta learning aims to adapt or generalize well on new tasks, which resembles how humans can learn new skills from a few examples. There are three approaches in meta learning: metric-based (Koch et al., 2015; Vinyals et al., 2016; Sung et al., 2018; Snell et al., 2017), model-based (Santoro et al., 2016; Munkhdalai & Yu, 2017; Grant et al., 2018) and optimization-based (Finn et al., 2017; 2018; Nichol et al., 2018). Neural processes (NPs) use model-based meta learning with stochasticity. Garnelo et al. (2018a) propose a conditional neural process as a new formulation to approximate a stochastic process using neural network architecture. It provides the advantage of Gaussian Processes (GPs) as it can estimate the uncertainty of its predictions, without having expensive inference time. Garnelo et al. (2018b) generalize a conditional neural process by adding latent variables, which are approximated using variational inference. Although NPs can adapt to new tasks quickly without requiring much computation, NPs suffer from an underfitting problem. To alleviate the underfitting, Kim et al. (2019) propose a cross-attention module, which explicitly attends the elements in the context set to obtain better representations for the elements in the target set. As another way to address the underfitting problem, Gordon et al. (2020) propose a set convolutional layer under the assumption of translation equivariance of inputs and outputs, which is expanded to the latent variable counterpart in Foong et al. (2020).

The present disclosure describes training of TPPs in a meta learning framework. Each sequence is treated as a “task”, since it is a realization of a stochastic process with its own characteristics. For instance, consider the pickup times of taxis in a city. The dynamics of these event sequences are governed by many factors such as location, weather, and the routine of a taxi driver, which implies the pattern of each sequence can differ significantly. Under the supervised learning framework, a trained model tends to capture the patterns seen in training sequences well, but it easily breaks on unseen patterns.

As the goal of modeling TPPs is to estimate the true probability distribution of the next event time given the previous event times, the technology described herein will adapt NPs, a family of model-based meta learning with stochasticity, for use in the TPP context. NTPPs are formulated as NPs by satisfying some conditions of NPs. The techniques described herein are described as “meta temporal point processes” or “Meta TPP”. According to the present disclosure, Meta TPP may be enhanced with a cross-attention module, referred to herein as “Attentive TPP”.

### Neural Processes

A general form of optimization objective in supervised learning is defined as,

$${θ}^{*} = arg {max}_{θ} {B ∼ p ( )}_{} [ {\sum }_{( x , y ) ∈ B} log {p}_{θ} ( y \vert x ) ] \qquad ( 1 )$$

where [symbol] :={(x⁽ⁱ⁾, y⁽ⁱ⁾)}ᵢ₌₁^{|} [symbol] ^{|} for an input x and label y, and B denotes a mini-batch set of (x, y) data pairs. Here, the goal is to learn a model f parameterized by θ that maps x to y as f_{θ}:x→y.

Meta learning is an alternative to supervised learning as it aims to adapt or generalize well on new tasks (Santoro et al., 2016), which resembles how humans learn new skills from few examples. In meta learning, a meta dataset, that is, a set of different tasks, is defined as [symbol] :={ [symbol] ⁽ⁱ⁾}ᵢ₌₁^{|} [symbol] ^{|}. Here, [symbol] ⁽ⁱ⁾ is a dataset of i-th task consisting of a context and target set as [symbol] := [symbol] ∪τ. The objective of meta learning is then defined as,

$${θ}^{*} = arg {max}_{θ} {{B}_{𝒟} ∼ p ( )}_{} [ {\sum }_{( , 𝒯 ) ∈ {B}_{𝒟}} log {p}_{θ} ( \vert , 𝒞 ) ] \qquad ( 2 )$$

where B_{D} denotes a mini-batch set of tasks. Also, [symbol] _{T} and [symbol] _{T} represent inputs and labels of a target set, respectively. Unlike supervised learning, the goal is to learn a mapping from x to y given [symbol] : more formally, fθ(·, [symbol] ):x→y. Although meta learning is a powerful framework to learn fast adaption to new tasks, it does not provide uncertainty for its predictions, which is becoming more important in modern machine learning literature as a metric to measure the reliability of a model.

Instead of finding point estimators as done in regular meta learning models, NPs learn a probability distribution of a label y given an input x and context set [symbol] : p_{θ}(y|x, [symbol] ). The present disclosure describes a technological implementation of an approach in which TPPs are framed as meta learning instead of supervised learning, employing NPs to incorporate the stochastic nature of TPPs.

### Neural Temporal Point Processes.

TPPs are stochastic processes where their realizations are sequences of discrete events in time. In notations, a collection of event time sequences is defined as [symbol] : ={s⁽ⁱ⁾}ᵢ₌₁^{|} [symbol] ^{|} where s⁽ⁱ⁾=(τ₁⁽ⁱ⁾, τ₂⁽ⁱ⁾, . . . , τ_{L}_{ᵢ}⁽ⁱ⁾) and Lᵢ denotes the length of i-th sequence. The history of studying TPPs started decades ago (Daley & Vere-Jones, 2003), but the present disclosure focuses on NTPPs where TPPs are modeled using neural networks (Shchur et al., 2021).

Generally, NTPPs are auto-regressively modeled in a supervised learning framework. More formally, the objective of NTPPs are defined as,

$${θ}^{*} = arg {max}_{θ} {B ∼ p ( 𝒟 )}_{} [ {\sum }_{i = l}^{\vert B \vert} {\sum }_{l = 1}^{{L}_{i} - 1} log {p}_{θ} ( {τ}_{l + 1}^{( i )} \vert {τ}_{\leq l}^{( i )} ) ] \qquad ( 3 )$$

where B˜p( [symbol] ) denotes a mini-batch of event time sequences.

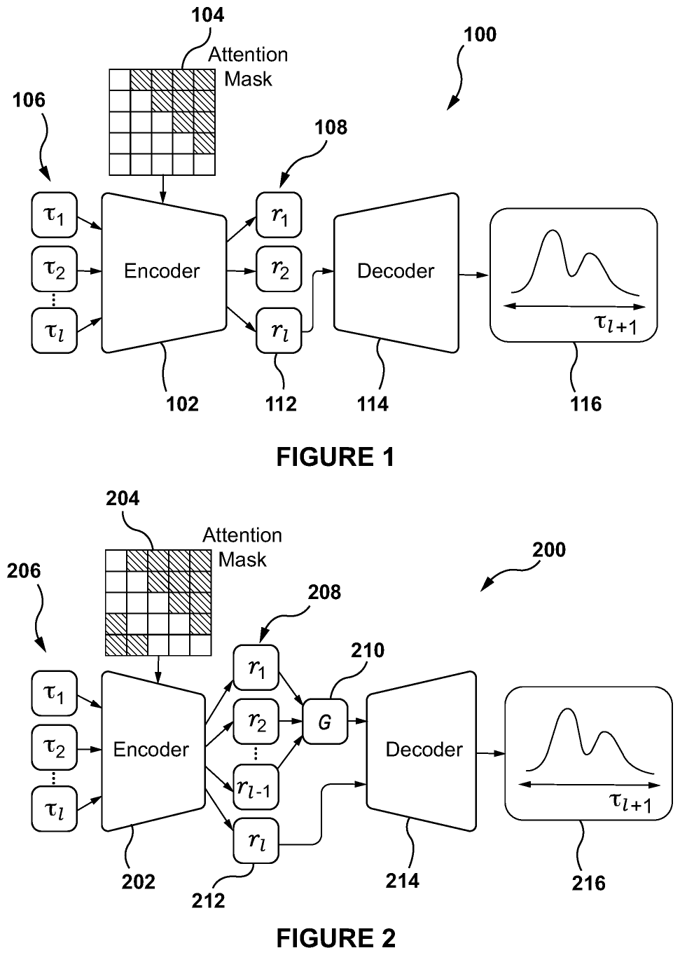

FIG. 1 shows a schematic representation of a general form of a NTPP model, indicated generally at reference 100. A trained encoder 102 applies an attention mask 104. In the NTPP model 100 shown in FIG. 1, the attention mask 104 prohibits the use of subsequent events to build the prediction model; only events prior to the event to be predicted are used to develop the objective function using Equation (3). The attention mask 104 still permits the use of the entire event history. Thus, the encoder 102 receives an event series 106 comprising a plurality of discrete event times τ₁, τ₂ . . . τₗ, and outputs an encoded history 108 of context features r₁, r₂ . . . rₗ, which is derived from the event times in the event series 106. A trained decoder 114 receives the most recent one rₗ 112 of the context features r₁, r₂ . . . rₗ in the encoded history 108 and outputs a prediction (probability distribution) 116 of the time when the next event τₗ₊₁ is expected to happen.

To frame TPPs as NPs, it is necessary to define a target input and context set shown in Equation (2), from an event time history τ_{≤l}.

### Meta Temporal Point Process

### Temporal Point Processes as Neural Processes

To frame TPPs as NPs, each event time sequence s is treated as a task for meta learning, since each sequence is a realization of a stochastic process. For instance, the transaction times of different account holders are very different from each other due to many factors including an account holder's financial status and characteristics.

With the new definition of tasks, a target input and context set is defined for a conditional probability distribution of meta learning shown in Equation (2), using previous event times τ_{≤l}. There are many ways to define them but a target input and context set need to be semantically aligned since the target input will be an element of the context set for the next event time prediction. Hence, a target input for τₗ₊₁ is defined as the latest “local history” τ_{l-k+1:l} where k is the window size of the local history. Similarly, a context set for τₗ₊₁ is defined as [symbol] ₗ:={τ_{t-k+1:t}}ₜ₌₁^{l-1}. Here, if t−k≤0, event times from τ₁ are included. With a transformer structure, the feature embeddings (context features) for the context set C can be efficiently computed.

### Conditional Meta TPP

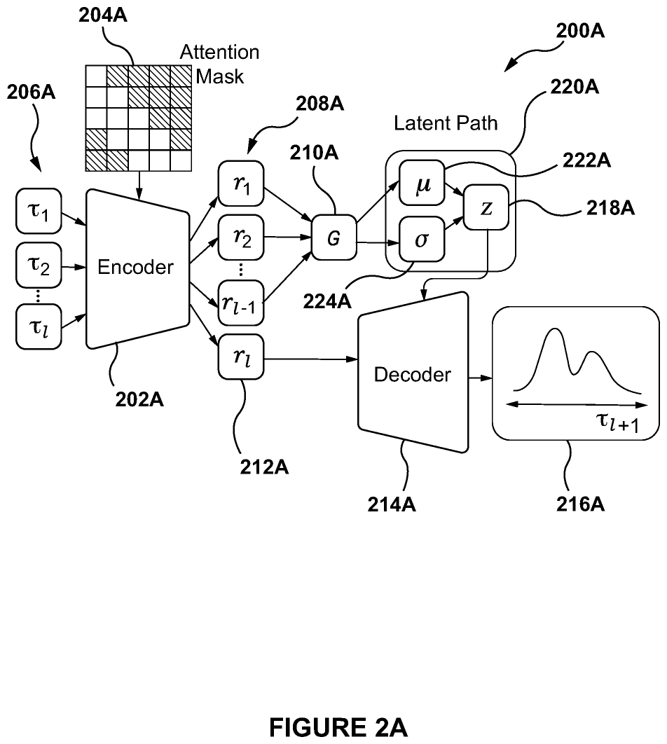

FIG. 2 shows a schematic representation of an approach described herein as “Conditional Meta TPP”, indicated generally at reference 200. Similarly to the general NTPP model 100 shown in FIG. 1, the Conditional Meta TPP model 200 comprises a trained encoder 202 that applies an attention mask 204, and the encoder 202 receives an event series 206 comprising a plurality of discrete event times τ₁, τ₂ . . . τₗ and outputs an encoded history 208 of context features r₁, r₂ . . . rₗ, where the encoded history is derived from the event times τ₁, τ₂ . . . τₗ in the event series 206. In the Conditional Meta TPP model 200, the attention mask 204 imposes a local history window size of k. Thus, the encoded history 208 is restricted to a local history window of size k, where the local history window excludes those of the event times that are more than k events ago. According to the Conditional Meta TPP model 200, a global feature G 210 is generated from the encoded history 208. Generating the global feature G 210 is performed using a subset r₁, r₂ . . . rₗ₋₁ of the encoded history 208 that excludes a most recent one n 212 of the context features r₁, r₂ . . . rₗ in the encoded history 208. The global feature G 210, along with the most recent one n 212 of the context features r₁, r₂ . . . rₗ in the encoded history 208, are provided to a trained decoder 214. The decoder 214 takes as input the concatenated feature of G 210 and rₗ 212. In the illustrated embodiment, the decoder 214 consists of two fully connected layers; this is merely illustrative and not limiting. The decoder 214 outputs a prediction (probability distribution) 216 for a time τₗ₊₁ of the next event. The prediction 216 is derived from the global feature G 210 and the most recent one rₗ 212 of the context features r₁, r₂ . . . rₗ. For illustrative purposes, FIG. 2 shows an example case of 5 (five) event times with a local history window size of k=3, this is merely illustrative and not limiting.

As noted above, in the Conditional Meta TPP model 200, the attention mask 204 imposes a local history window size of k. Then, the most recent context feature rₗ 212 contains information of τ_{l-k+1:l}. With the notations for target inputs and context sets, the objective of TPPs in a meta learning framework can be presented as:

$${θ}^{*} = arg {max}_{θ} {B ∼ p ( 𝒟 )}_{} [ {\sum }_{i = l}^{\vert B \vert} {\sum }_{l = 1}^{{L}_{i} - 1} log {p}_{θ} ( {τ}_{l + 1}^{( i )} \vert {τ}_{l - k + 1 : l}^{( i )} , {l}_{( i )}^{} ) ] . \qquad ( 4 )$$

Note that there is only one target label [symbol] to predict per event unlike the general meta learning objective in Equation (2) where usually | [symbol] |>1. This is because TPP models in general are trained to predict the next event time.

Let [symbol] :={xᵢ}ᵢ₌₁^{|} [symbol] ^{|} and [symbol] :={yᵢ}ᵢ₌₁^{|} [symbol] ^{|} be a set of target inputs and labels, respectively, and π be an arbitrary permutation of a set (not the value 3.1415 . . . used in the geometry of circles). To design NP models, it is necessary to satisfy the following two conditions: (a) consistency over a target set; and (b) permutation invariance over a target set.

A probability distribution p_{θ} is consistent if it is consistent under permutation: p_{θ}( [symbol] | [symbol] , [symbol] )=p_{θ}(π( [symbol] )|π( [symbol] ), [symbol] ), and marginalization: p_{θ}(y_{1:m}| [symbol] , [symbol] )=∫p_{θ}(y_{1:n}| [symbol] , [symbol] ) dy_{m+1:n} for any positive integer m<n.

According to Kolmogorov extension theorem (Oksendal, 2013), a collection of finite-dimensional distributions is defined as a stochastic process if consistency over a target set is satisfied. In NP literature, consistency over a target set is satisfied through factorization: it assumes target labels are independent to each other given a target input and a context set C, in other words, p_{θ}( [symbol] | [symbol] , [symbol] )=Πᵢ₌₁^{|} [symbol] ^{|}p_{θ}(yᵢ|xᵢ, x_{<i}, y_{<i}, [symbol] )≈Πᵢ₌₁^{|} [symbol] ^{|}p_{θ}(yᵢ|xᵢ, [symbol] ) (Dubois et al., 2020). This assumption can be unrealistic if target labels are strongly dependent on previous target inputs and labels even after context representations are observed. It is, however, not necessary to assume factorization to represent TPPs as NPs. As previously mentioned, the objective is predicting the next event time, which means | [symbol] |=1. When a set contains only one element, its permutation is always itself. More formally, the required consistency under permutation in TPPs: p_{θ}(τₗ₊₁|τ_{l-k+1:l}, [symbol] ₗ)=p_{θ}(π(τₗ₊₁)|π(τ_{l-k+1:l}), [symbol] ₗ), is satisfied since π({τₗ₊₁})={τₗ₊₁} and π({τ_{l-k+1:l}})={τ_{l-k+1:l}}. Also, the required marginalization under permutation is satisfied as marginalization is not applicable for p_{θ}(τₗ₊₁|τ_{l-k+1:l}, [symbol] ₗ) since the target label set τₗ₊₁ contains only one element. Thus, both consistency under permutation and marginalization is satisfied and hence consistency over a target set is satisfied.

Permutation invariance over a target set is satisfied if p_{θ}( [symbol] | [symbol] , [symbol] )=p_{θ}( [symbol] | [symbol] , π( [symbol] ). Recall that NP models learn a probability distribution of a target label p_{θ} given a target input and context set. For computational efficiency (to make inference [symbol] (| [symbol] |+| [symbol] |) time), the feature representation of C should be invariant to the size of the context set, for which permutation invariance over a target set is required. To satisfy permutation invariance over a target set, the context features r₁, r₂, . . . rₗ₋₁ may be averaged (or otherwise subjected to a permutation-invariant operation, e.g. summation) to generate the global feature G 210 as shown in FIG. 2. Each context feature r₁, r₂, . . . , rₗ₋₁ represents a feature from a transformer encoder such as Transformer Hawkes Processes (THP), that encodes the corresponding local history of the context set [symbol] ₗ. For instance, rᵢ contains information of τ_{i-k+1:i}. To make rᵢ only encode the subset of previous event times τ_{i-k+1:i} (instead of encoding all previous event times τ_{≤i}), the attention mask 204 is used to mask out events that are outside of the local history window, as shown in FIG. 2. Of note, the attention mask 204 is different from the attention mask 104 shown in FIG. 1, since the attention mask 104 in FIG. 1 still permits the use of the entire event history. Using the permutation invariant feature G not only satisfies permutation invariance over a target set, but also lets the decoder 214 approximate the probability distribution of a target label given both a target input and context set instead of just a target input. Now that both the requirements of (a) consistency over a target set; and (b) permutation invariance over a target set are satisfied by the above-described architectural design, TPPs can be treated as NPs.

It can be expensive to compute the individual context feature rₜ for all 1≤t<l, from each element of the context set τ_{t-k+1:t}∈ [symbol] ₗ: the time complexity of computing all the context features for a sequence is [symbol] (L²). Instead of passing each element of a context set, using the Transformer architecture (Vaswani et al., 2017), the event times can be passed to obtain all the context features at once, of which time complexity is [symbol] (kL) where k is the size of the local history window imposed by the attention mask 204. THP may be employed as the encoder, as described in Zuo et al. (2020). This is merely an illustrative implementation, and is not intended to be limiting.

### Meta TPP

NPs are generally modeled as latent variable models. Instead of using the deterministic global feature G as an input to the decoder (Garnelo et al., 2018a), a latent variable z is sampled from a probability distribution e.g. multi-variate Gaussian, using parameters inferred from the global feature G (Garnelo et al., 2018b). As it is intractable to compute the log-likelihood for a latent variable model, amortized variational inference (VI) can be used to approximate inference. In the setting of TPPs, the evidence lower bound (ELBO) of variational inference with an inference network p_{θ}(z| [symbol] _{L}) can be derived as,

$$log {p}_{θ} ( {τ}_{l + 1} \vert {τ}_{l - k + 1 : l} , {l}_{} ) = log \int {p}_{θ} ( {τ}_{l} \vert {τ}_{l - k + 1 : l} , z ) {p}_{θ} ( z \vert {l}_{} ) dz \qquad ( 5 )$$

$$\geq {z}_{} [ log {p}_{θ} ( {τ}_{l + 1} \vert {τ}_{l - k + 1 : l} , z ) ] - KL ( {p}_{θ} ( z \vert {L}_{} ) \vert {p}_{θ} ( z \vert {l}_{} ) ) \qquad ( 6 )$$

$$\approx \frac{1}{N} {\sum }_{n = 1}^{N} log {p}_{θ} ( {τ}_{l} \vert {τ}_{l - k + 1 : l} , {z}_{n} ) - KL ( {p}_{θ} ( z \vert {L}_{} ) \vert {p}_{θ} ( z \vert {l}_{} ) ) \qquad ( 7 )$$

where N denotes the number of samples of z˜p_{θ}(z| [symbol] _{L}) for Monte-Carlo (MC) approximation. Here, p_{θ}(z| [symbol] _{L}) is the posterior given the context at the last (L-th) event, which contains all the events of the sequence s (it is accessible in training time). Minimizing KL-divergence between p_{θ}(z| [symbol] _{L}) and p_{θ}(z| [symbol] ₗ) is to make the global latent variable z inferred from [symbol] ₗ be similar to the latent variable of a sequence z from [symbol] _{L}, in training time. To sample z, the reparameterization technique is used as z=μ+σ⊙∈ where ∈˜ [symbol] (0,I). At inference, evaluation metrics such as negative log-likelihood (NLL) or root mean squared error may be approximated using MC samples. But, lacking access to [symbol] _{L} at l^{th} event when l<L, z from p_{θ}(z| [symbol] ₗ) is used.

Detailed steps to derive the ELBO of the Meta TPP model shown in Equation (6) are set out below:

$$log {p}_{θ} ( {τ}_{l} \vert {τ}_{l - k : l - 1} , {l}_{} ) = log \int {p}_{θ} ( {τ}_{l} \vert {τ}_{l - k : l - 1} , z ) {p}_{θ} ( z \vert {l}_{} ) dz$$

$$= log \int {p}_{θ} ( z \vert {L}_{} ) \frac{{p}_{θ} ( z \vert {l}_{} )}{{p}_{θ} ( z \vert {L}_{} )} {p}_{θ} ( {τ}_{l} \vert {τ}_{l - k : l - 1} , z ) dz \qquad ( 8 )$$

$$\geq \int {p}_{θ} ( z \vert {L}_{} ) log \frac{{p}_{θ} ( z \vert {l}_{} )}{{p}_{θ} ( z \vert {L}_{} )} {p}_{θ} ( {τ}_{l} \vert {τ}_{l - k : l - 1} , z ) dz \qquad ( 9 )$$

$$= {z ∼ {p}_{θ} ( z \vert {L}_{} )}_{} [ log {p}_{θ} ( {τ}_{l} \vert {τ}_{l - k : l - 1} , z ) ] - KL ( {p}_{θ} ( z \vert {L}_{} ) \vert {p}_{θ} ( z \vert {l}_{} ) ) .$$

With respect to the above derivation, Equations (8) and (9) hold with Jensen's inequality.

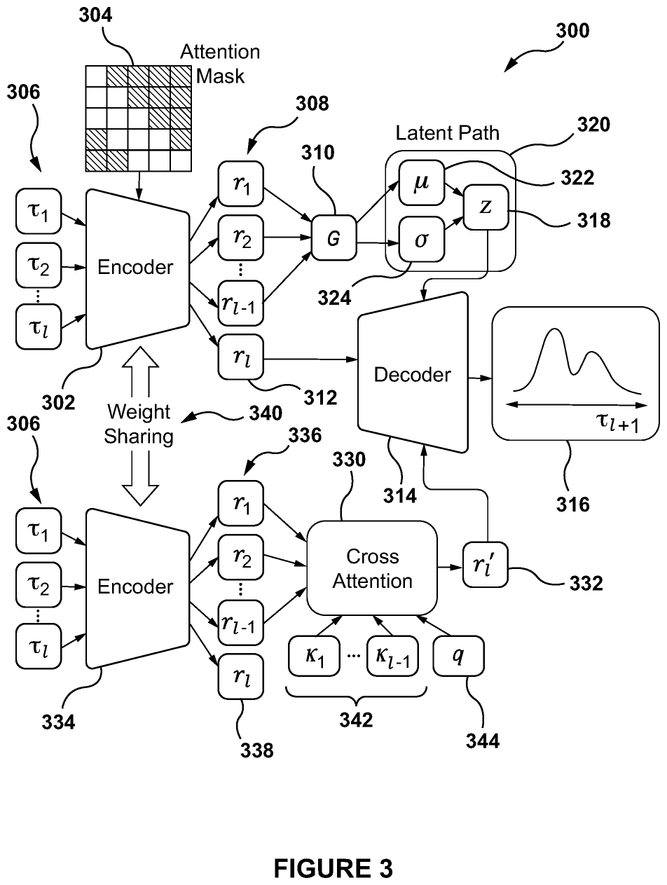

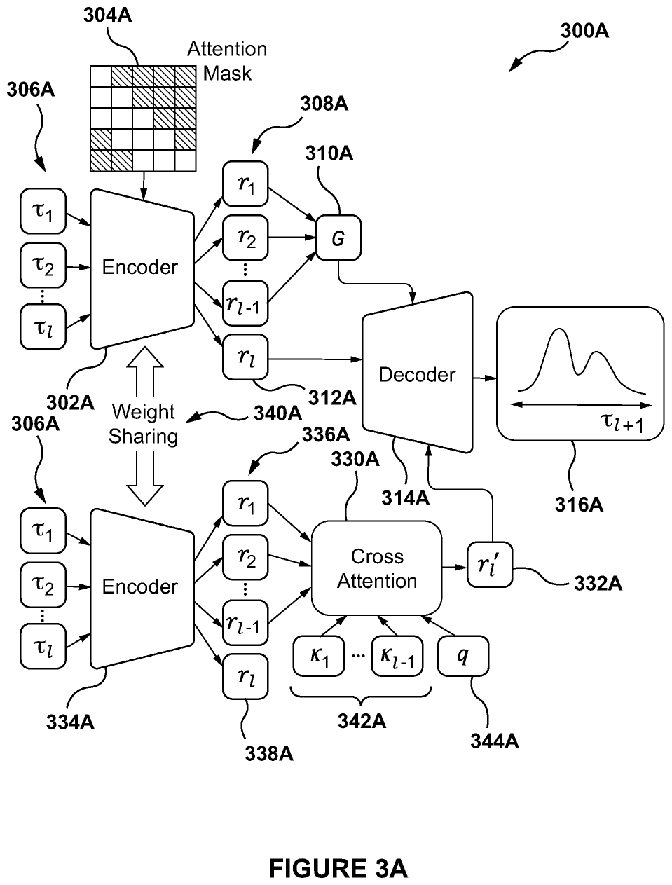

FIG. 2A shows how the Conditional Meta TPP model 200 shown in FIG. 2 can be modified to use a latent variable. In FIG. 2A, like reference numerals denoting like features to those in FIG. 2, except with the suffix “A”. The latent variable model 200A shown in FIG. 2A is referred to as a Meta Temporal Point Process model or Meta TPP model. Instead of providing the global feature G 210 to the decoder 214 as in the Conditional Meta TPP model 200 shown in FIG. 2, in the Meta TPP model 200A in FIG. 2A, the global latent variable z 218A for the global feature G 210A may be provided to the decoder 214A. To sample z 218A, the reparameterization technique is used as z=μ+σ⊙∈ where ∈˜ [symbol] (0, I) as shown in the latent path 220A in FIG. 3, which includes the mean u 222A and standard deviation σ 224A. The decoder 214A would then take as input the concatenated feature of the global latent variable z 218A and n 212A, with both being D-dimensional vectors. The decoder 214A consists, in the illustrated embodiment, of two fully connected layers, and the input and hidden dimension of the decoder layers are 2D. This is merely illustrative and not limiting.

An advantage of a latent variable model is that it captures stochasticity of functions, which can be particularly beneficial for modeling TPPs since TPPs are stochastic processes. Experiments described further below demonstrate it indeed helps to model TPPs over the deterministic case. In particular, it is robust to noise.

TPP models treat all event sequences as a realization of the same process whereas the Meta TPP model described herein treats each sequence as a realization of a distinct stochastic process. This is achieved by conditioning on the global latent feature z that captures task-specific characteristics. For z to be task-specific, it has to be distinct for different sequences but similar throughout different events l ∈[1, L−1] within the same sequence. It is natural for the global features to be distinct by sequence but further guidance is needed to make the global feature shared across all the event times in a sequence. Due to the permutation invariance constraint implemented in averaging, z cannot be very different at different event times: adding some additional context feature rᵢ will not substantially change G or z. In addition, the Kullback-Leibler Divergence (KL Divergence) between p_{θ}(z| [symbol] _{L}) and p_{θ}(z| [symbol] ₗ) further enhances the task-specific characteristics of z.

For the global latent variable z, additional guidance is provided, which is clearer with the objective of the variational inference. Recall that the objective of the variational inference in Equation (6) is provided as:

$$arg {max}_{θ} {E}_{z ∼ {p}_{θ} ( z \vert {L}_{} )} log {p}_{θ} ( {τ}_{l} \vert {τ}_{l - k : l - 1} , z ) - KL ( {p}_{θ} ( z \vert {L}_{} ) \vert \vert {p}_{θ} ( z \vert {l}_{} ) ) .$$

Here, regardless of the index of the target l, it always minimizes the KL Divergence between p_{θ}(z| [symbol] _{L}) and p_{θ}(z| [symbol] ₗ) where L is the length of a sequence. So, ideally, the global latent variable z˜p_{θ}(z| [symbol] ₗ) should capture the same information as z˜p_{θ}(z| [symbol] _{L}). It implies that regardless of the index of the target l, the latent variable z asymptotically captures the global feature of the whole sequence, which is equivalent to z˜p_{θ}(z| [symbol] _{L}). Hence, the resulting p_{θ}(z| [symbol] ₗ) captures the global and task-specific patterns, which ideally is similar to p_{θ}(z| [symbol] _{L}). As a result, the global latent variable z is guided to be distinct for different sequences but similar throughout different event time l∈ [1, L−1] within the same sequence.

The role of the global latent variable z is quite different from the role of the target input τ_{l-k+1:l} which is another input for the decoder 214A. Consider two events that are far apart from each other. Due to distinctive local patterns, their target inputs can be quite different from each other. On the other hand, the global features will not be that different as they are the average of all the context features at each event time, as guided by the KL Divergence. Hence, the global feature provides “overall” patterns of a task whereas a target input provides local patterns to the decoder. Returning to the goal of treating each sequence as a realization of a distinct stochastic process, a global latent variable z that is distinct by each sequence is used to provide task-specific information which is shared regardless of different event time step l. It is neither implicitly nor explicitly considered in the supervised learning case. In supervised learning, each event time step at each sequence is treated equally from which patterns for only one stochastic process is learned.

### Attentive Temporal Point Process

To alleviate potential underfitting, a cross-attention module may be used to consider the similarity between the feature of a target input and the event series 306 of previous event times.

Reference is now made to FIG. 3, which is a schematic representation of an Attentive TPP model, indicated generally at reference 300. The Attentive TPP model 300 is similar to the Meta TPP model 200A described above, with the further addition of a cross-attention module 330. Hence, the term “Attentive TPP” is used to describe the model 300 illustrated in FIG. 3.

The Attentive TPP model 300 comprises a trained prediction encoder 302 that applies an attention mask 304. The prediction encoder 302 receives an event series 306 comprising a plurality of discrete event times τ₁, τ₂ . . . τₗ and outputs an encoded history 308 of context features r₁, r₂ . . . rₗ, where the encoded history is derived from the event times τ₁, τ₂ . . . τₗ in the event series 306. As with the Conditional Meta TPP model 200 and the Meta TPP model 200A, in the Attentive TPP model 300 the attention mask 304 imposes a local history window size of k restricting the encoded history 308 to a local history window of size k, so as to exclude event times that are more than k events ago. Also similarly to the Conditional Meta TPP model 200 and the Meta TPP model 200A, in the Attentive TPP model 300 a global feature G 310 is generated from the encoded history 308. The global feature G 310 is generated using a subset r₁, r₂ . . . rₗ₋₁ of the encoded history 308 that excludes a most recent one n 312 of the context features r₁, r₂ . . . rₗ in the encoded history 308.

As with the Meta TPP method 200A described above in the context of FIG. 2A, in the Attentive TPP model 300 a global latent variable z 318 for the global feature G 310 is provided to a trained decoder 314. To sample z 318, the reparameterization technique is again used as z=μ+σ⊙∈ where ∈˜ [symbol] (0, I) as shown in the latent path 320 in FIG. 3, which includes the mean μ 322 and standard deviation σ 324. In addition to the global latent variable z 318 for the global feature G 310, the most recent one n 312 of the context features r₁, r₂ . . . rₗ in the encoded history 308 is also provided to the decoder 314, which outputs a prediction 316 for a time τₗ₊₁ of the next event. However, in the Attentive TPP model 300 a cross-attention module 330 applies cross-attention to the subset r₁, r₂ . . . rₗ₋₁ of the encoded history 308 to generate an attention feature r′ 332 and provides the attention feature rₗ′ 332 to the decoder 314. The prediction 316 is derived from the global latent variable z 318 for the global feature G 310 (and hence indirectly from the global feature G 310), the most recent one rₗ 312 of the context features r₁, r₂ . . . rₗ and the attention feature rₗ′ 332.

An attention encoder 334 receives the event series 306 comprising the discrete event times τ₁, τ₂ . . . τₗ and outputs an encoded history 336 of context features r₁, r₂ . . . rₗ, where the encoded history 336 is derived from the event times τ₁, τ₂ . . . τₗ in the event series 306. A subset r₁, r₂ . . . rₗ₋₁ of the encoded history 336, which excludes the most recent one rₗ 338 of the context features r₁, r₂ . . . rₗ in the encoded history 336, is fed to the cross-attention module 330.

In addition to the subset r₁, r₂ . . . rₗ₋₁ of the encoded history 336, the cross-attention module 330 also receives cross-attention inputs k₁, k₂, . . . , kₗ₋₁ 342 and q 344.

Given the local history (context) features r₁, r₂, . . . rₗ₋₁ at l-th time step, the key-query-value pairs K∈ [symbol] ^{l-1×D}, q∈R^{1×D}, and V∈ [symbol] ^{l-1×D} for the cross-attention, are computed using their corresponding projection weights W_{K}∈ [symbol] ^{D×D}, W_{Q}∈ [symbol] ^{D×D} as,

$$K = R \cdot {W}_{K} , q = {r}_{l}^{T} \cdot {W}_{Q} , V = R where R = {[ {r}_{1} , {r}_{2} , … , {r}_{l - 1} ]}^{T} . \qquad ( 10 )$$

Here, K corresponds to [k₁, k₂, . . . , kₗ₋₁]^{T} (see FIG. 3). The feature of i-th attention head hᵢ are then computed as follows,

$${h}_{i} = Softmax ( q \cdot {K}^{T} / \sqrt{D} ) \cdot V . \qquad ( 11 )$$

With W∈ [symbol] ^{HD×D} and some fully connected layers denoted as FC, r′ₗ∈ [symbol] ^{1×D} is computed as,

$${r}_{l}^{′} = FC ( [ {h}_{1} , {h}_{2} , … , {h}_{H} ] \cdot W ) . \qquad ( 12 )$$

The decoder 314 takes the concatenated feature of z 318, rₗ 312, and r′ₗ 332 as an input to infer a probability distribution as the prediction 316. More particularly, the decoder 314 takes the concatenated feature of the global latent feature z 318 and the target input feature rₗ 312 that encodes τ_{l-k:l-1} from the prediction encoder 302, and takes the attention feature r′ₗ 332 from the cross-attention module 330. Here, z, rₗ, and r′ₗ are all D-dimensional vectors. The decoder 314 in the illustrated embodiment consists of two fully connected layers, and the input and hidden dimension of the decoder layers are 3D.

FIG. 3A shows a modified form of the Attentive TPP model, denoted generally by reference 300A. The modified Attentive TPP model 300A is identical to the Attentive TPP model 300 shown in FIG. 3, with like reference numerals denoting like features except with the suffix “A”, except that the global feature G 310 is provided to the correspondingly configured decoder 314 instead of a global latent variable z. Thus, there is no latent path in the modified Attentive TPP model 300A.

In the illustrated embodiments of the Attentive TPP model 300, 300A the prediction encoder 302, 302A is a first encoder and the attention encoder 334, 334A is a second encoder, with the prediction encoder 302, 302A and the attention encoder 334, 334A differing from one another although sharing some model parameters, as illustrated by weight sharing 340, 340A. In other embodiments, the prediction encoder and the attention encoder may differ from one another with no shared parameters, or may be duplicate encoders. In other embodiments, the prediction encoder and the attention encoder may be subsumed into a single encoder that feeds the same encoded history of context features r₁, r₂ . . . rₗ to both the decoder and the cross-attention module.

In the TPP setting, it is common that there are multiple periodic patterns in the underlying stochastic process. The cross-attention module 330, 330A provides an inductive bias to the Attentive TPP model 300, 300A to the effect that that the repeating event subsequences should have similar features. The experiments described below demonstrate that the explicit attention helps to model TPPs in general, especially when there are periodic patterns.

The decoder 114, 214, 214A, 314, 314A outputs the parameters of the probability distribution of the next event time or p_{θ}(τₗ₊₁|τ_{l-k+1:l}, zₘ). Similarly to intensity-free TPP (Shchur et al., 2020), a mixture of log-normal distributions is used to model the probability distribution. Formally, for l∈ [1, L−1], τₗ₊₁˜MixLogNorm(μₗ₊₁, σₗ₊₁, ωₗ₊₁) where μₗ₊₁ are the mixture means, σₗ₊₁ are the standard deviations, and ωₗ₊₁ are the mixture weights.

Unlike Equation (7) where the ELBO is computed using samples from p_{θ}(z| [symbol] _{L}), in inference, there is no access to z˜p_{θ}(z| [symbol] _{L}). But, as p_{θ}(z| [symbol] ₗ) is trained to be similar to p_{θ}(z| [symbol] _{L}) through KL (p_{θ}(z| [symbol] _{L})|p_{θ}(z| [symbol] ₗ), samples z˜p_{θ}(z| [symbol] ₗ) are used.

As described below in the context of the hyperparameters used, at inference 256 samples are used to provide adequate approximation.

For NLL a log-likelihood of the next event time τₗ₊₁ is approximated using MC approximation as,

$$log {p}_{θ} ( {τ}_{l + 1} \vert {τ}_{l - k + 1 : l} , {l}_{} ) = log \int {p}_{θ} ( {τ}_{l + 1} \vert {τ}_{l - k + 1 : l} , z ) {p}_{θ} ( z \vert {l}_{} ) dz \qquad ( 13 )$$

$$\approx log \frac{1}{M} {\sum }_{m = 1}^{M} {p}_{θ} ( {τ}_{l + 1} \vert {τ}_{l - k + 1 : l} , {z}_{m} ) \qquad ( 14 )$$

where M is the number of samples from p_{θ}(z| [symbol] ₗ).

For Root Mean Squared Error (RMSE) a mixture of log-normal distributions is used to model p_{θ}(τₗ₊₁|τ_{l-k+1:l}, z). Formally, for l∈[1, L−1], Σₗ₊₁˜MixLogNorm(μₗ₊₁, σₗ₊₁, ωₗ₊₁) where μₗ₊₁ are the mixture means, σₗ₊₁ are the standard deviations, and ωₗ₊₁ are the mixture weights. The parameters are the outputs of the decoder given a latent sample z. Knowing this, the expected event time for a latent sample z with K mixture components can be analytically computed as,

$${E}_{{τ}_{l + 1} ∼ {p}_{θ} ( {τ}_{l + 1} \vert {τ}_{l - k + 1 : l} , z )} [ {τ}_{l + 1} ] = {\sum }_{k = 1}^{K} {ω}_{l + 1 , k} exp ( {μ}_{l + 1 , k} + \frac{1}{2} {σ}_{l + 1 , k}^{2} ) .$$

Note that since this expectation is over p_{θ}(τₗ₊₁|τ_{l-k+1:l}, z) where z is one sample from the posterior, another expectation over the posterior is taken as follows,

$${E}_{{τ}_{l + 1} ∼ {p}_{θ} ( {τ}_{l + 1} \vert {τ}_{l - k + 1 : l} , {l}_{} )} [ {τ}_{l + 1} ] = {E}_{z ∼ {p}_{θ} ( z \vert {l}_{} )} {E}_{{τ}_{l + 1} ∼ {p}_{θ} ( {τ}_{l + 1} \vert {τ}_{l - k + 1 : l} , z )} [ {τ}_{l + 1} ] \qquad ( 13 )$$

$$= {E}_{z ∼ {p}_{θ} ( z \vert {l}_{} )} {\sum }_{k = 1}^{K} {ω}_{l + 1 , k} exp ( {μ}_{l + 1 , k} + \frac{1}{2} {σ}_{l + 1 , k}^{2} ) \qquad ( 16 )$$

$$\approx \frac{1}{M} {\sum }_{m = 1}^{M} {\sum }_{k = 1}^{K} {ω}_{l + 1 , k} exp ( {μ}_{l + 1 , k} + \frac{1}{2} {σ}_{l + 1 , k}^{2} ) \qquad ( 17 )$$

where M is the number of samples from p_{θ}(z| [symbol] ₗ).

In terms of accuracy, class predictions are obtained by taking argmax over the probability distribution of class labels as follows,

$$arg {max}_{c ∈ [ 1 , C ]} {p}_{θ} ( {y}_{l + 1} \vert {τ}_{l - k + 1 : l} , {y}_{l - k + 1 : l} , {l}_{} )$$

where C is the number of marks. The probability distribution of class labels is approximated using MC samples as,

$${p}_{θ} ( {y}_{l + 1} \vert {τ}_{l - k + 1 : l} , {y}_{l - k + 1 : l} , {l}_{} ) = \int {p}_{θ} ( {y}_{l + 1} \vert {r}_{l} , z ) {p}_{θ} ( z \vert {l}_{} ) dz \qquad ( 18 )$$

$$\approx \frac{1}{M} {\sum }_{m = 1}^{M} {p}_{θ} ( {y}_{l + 1} \vert {r}_{l} , {z}_{m} ) \qquad ( 19 )$$

where M is the number of samples from p_{θ}(z| [symbol] ₗ).

Of note, VI as described above is not the only way to approximate the latent variable model. MC approximation, which is simpler and does not rely on a proxy like ELBO, can also be used. It is formulated as,

$$log \int {p}_{θ} ( {τ}_{l + 1} \vert {τ}_{l - k + 1 : l} , z ) {p}_{θ} ( z \vert {l}_{} ) dz \approx log \frac{1}{N} {\sum }_{n = 1}^{N} {p}_{θ} ( {τ}_{l + 1} \vert {τ}_{l - k + 1 : l} , {z}_{n} ) \qquad ( 20 )$$

Note that a sample zₙ in Equation (20) is drawn from p(z| [symbol] ₗ), which is different from zₙ˜p(z| [symbol] _{L}) in Equation (7). For example, Foong et al. (2020) and Dubois et al. (2020) report that MC approximation generally outperforms variational inference. In variational inference, as a model is trained with z˜p_{θ}(z| [symbol] _{L}), the samples z˜p_{θ}(z| [symbol] ₗ) in test time are quite different from what the model has used as inputs: although KL(p_{θ}(z| [symbol] _{L})|p_{θ}(z| [symbol] ₗ)) forces p_{θ}(z| [symbol] _{L}) and p_{θ}(z| [symbol] ₗ) close to each other, it is hard to make KL Divergence equal to zero.

### Extension to Marked TPPs

Aspects of the methods described herein can be extended to marked cases by adding a class prediction branch similar to intensity-free TPP (Shchur et al., 2020). Suppose a mark at l+1-th event is denoted as yₗ₊₁. For the proposed Meta TPP approach, the log-likelihood of the mark may be computed as,

$$log {p}_{θ} ( {y}_{l + 1} \vert {τ}_{l - k + 1 : l} , {y}_{l - k + 1 : l} , {l}_{} ) = log \int {p}_{θ} ( {y}_{l + 1} \vert {τ}_{l - k + 1 : l} , {y}_{l - k + 1 : l} , z ) {p}_{θ} ( z \vert {l}_{} ) dz .$$

Note that [symbol] ₗ includes both event times and corresponding labels. For implementation, one fully connected layer is added; this added layer takes as input the same features for the decoder (that predicts the next event time), and outputs the logits for classification. A class prediction is made by taking argmax over the probability distribution which is approximated using MC samples as,

$${p}_{θ} ( {y}_{l + 1} \vert {τ}_{l - k + 1 : l} , {y}_{l - k + 1 : l} , {l}_{} ) \approx \frac{1}{M} {\sum }_{m = 1}^{M} {p}_{θ} ( {y}_{l + 1} \vert {r}_{l} , {z}_{m} )$$

Note that inputs τ_{l-k+1:l} and y_{l-k+1:l} are encoded to n. The class predictions to compute the accuracies reported throughout the experiments are made from this.

### Experiments

### Experimental Setting

### Datasets

To compare the effectiveness of models, experiments were conducted on four (4) popular benchmark datasets: Stack Overflow, Mooc, Reddit, and Wiki, and on three (3) newly processed datasets introduced in the present disclosure: Sinusoidal, Uber and NYC Taxi. The statistics are provided in Table 1 below:

TABLE 1
Statistics of the datasets.

| | # of | # of | Max Seq. | # of |
|---|---|---|---|---|
| Datasets | Seq. | Events | Length | Marks |
| Stack Overflow | 6,633 | 480,414 | 736 | 22 |
| Mooc | 7.047 | 389,407 | 200 | 97 |
| Reddit | 10,000 | 532,026 | 100 | 984 |
| Wiki | 1,000 | 138,705 | 250 | 7,628 |
| Sinusoidal | 1,000 | 107,454 | 200 | 1 |
| Uber | 791 | 701,579 | 2,977 | 1 |
| NYC Taxi | 1,000 | 1,141,379 | 1,958 | 1 |

To split the data into train, validation, and test, the splits made in previous works such as Shchur et al. (2020) and Yang et al. (2022) were followed. More specifically, a 60%, 20%, and 20% split for train, validation, and test, respectively, was used for all the datasets except for Stack Overflow, following Shchur et al. (2020). For Stack Overflow, the split made by Yang et al. (2022) and Du et al. (2016) was followed where 4,777, 530, and 1,326 samples are assigned for train, validation, and test, respectively. More detailed descriptions of the popular benchmark datasets are available in the original papers or Section E.2 of Shchur et al. (2020).

### Benchmark Datasets

Stack Overflow. This dataset was first processed in Du et al., (2016). The first folder of the dataset was used, following Shchur et al., (2020) and Yang et al. (2022).

Mooc. This dataset consists of 7,047 sequences, each of which contains action times of an individual user of an online Mooc course. There are 98 categories.

Reddit. This dataset consists of 10,000 sequences from the most active users with marks being the sub-reddit categories of each sequence.

Wiki. This dataset consists of 1,000 sequences from the most edited Wikipedia pages (for a one-month period) with marks being users who made at least 5 changes.

### New Datasets

Sinusoidal. This dataset is generated using a sine function with a periodicity of 4π and the domain of [0,32π] (in this case, π does refer to the value 3.1415 . . . used in the geometry of circles). The number of events per sequence in [20,200] was chosen randomly for 1,000 sequences.

Uber. The Uber dataset is generated using the data from the link https://www.kaggle.com/datasets/fivethirtyeight/uber-pickups-in-new-york-city/metadata. which is incorporated herein by reference. Among the data from January, 2015 to June 2015, sequences were created using Dispatching-base-num and locationID as keys, with a constraint that the minimum and maximum events per sequence were 100 and 3,000, respectively, and all overlapping event times were dropped.

NYC Taxi. The NYC Taxi dataset from the NYC Taxi pickup raw data in 2013 shared at the link http://www.andresmh.com/nyctaxitrips/, which is incorporated herein by reference; this is different from the one proposed in Du et al. (2016), as location information was not included. Six (6) different datasets were generated by splitting the whole data for 2013 into two (2) month blocks: January-February, March-April, May-June, July-August, September-October, and November-December. Throughout the experiment, models were trained on the training set of January-February split, and evaluated on the test set of January-February for in-domain, and other for distribution drift.

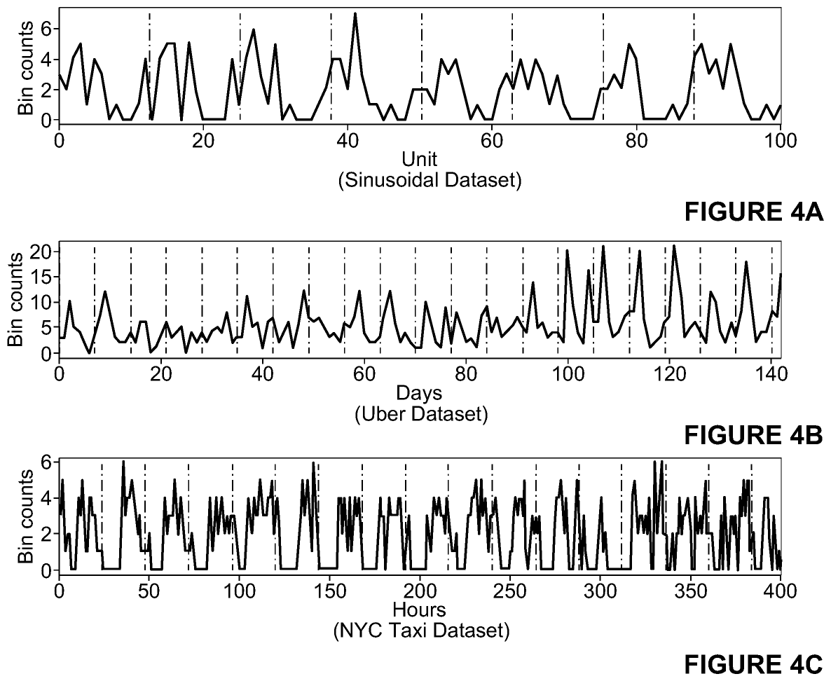

FIGS. 4A, 4B and 4C show visualizations of examples of, respectively, the Sinusoidal dataset, the Uber dataset, and the NYC Taxi dataset. As can be seen, each of the examples show strong periodicity. The Sinusoidal dataset has a periodicity for every 4π as shown in FIG. 4A, the Uber dataset has a weekly periodic pattern as shown in FIG. 4B, and the NYC Taxi dataset has a daily pattern as shown FIG. 4C. As discussed further below, the experimental results demonstrate the proposed Attentive TPP model captures periodic patterns better than the baselines.

### Metrics

The root mean squared error (RMSE) is used as the main metric along with the NLL as a reference since NLL can go arbitrarily low if the probability density is placed mostly on the ground truth event time. RMSE may not be a good metric, either, if one ignores stochastic components of TPPs and directly trains a baseline on the ground truth event times to obtain point estimations of event times (Shchur et al., 2021). All the methods were trained on NLL, and RMSE was obtained at test time, so as to avoid abuse of RMSE scores, keeping stochastic components of TPPs. For marked TPP datasets, the proposed method is extended to make class predictions, and accuracy is reported below.

### Baselines

Intensity-free TPP (Shchur et al., 2020), neural flow (Biloš et al., 2021), and THP (Zuo et al., 2020) are used as baselines. For intensity-free TPP and neural flow, the survival time of the last event is added to NLL, with correction of some bugs specified in their public repositories. THP and its variants are originally based on intensity: they predict intensities from which log-likelihood and expectation of event times are computed. It is, however, computationally expensive to compute them as it requires computation of integrals: especially, to compute the expected event times, it requires computation of double integrals, which can be quite expensive and complex to compute even with thinning algorithms described in Mei & Eisner (2017). To work around this limitation without losing performance, the mixture of log-normal distribution proposed in Shchur et al., (2020) is added as the decoder, and the result is referred to herein as THP⁺. For a fair comparison, the number of parameters of the models is fixed between 50K and 60K except for the last fully-connected layer for class predictions since it depends on the number of classes.

### Hyperparameters

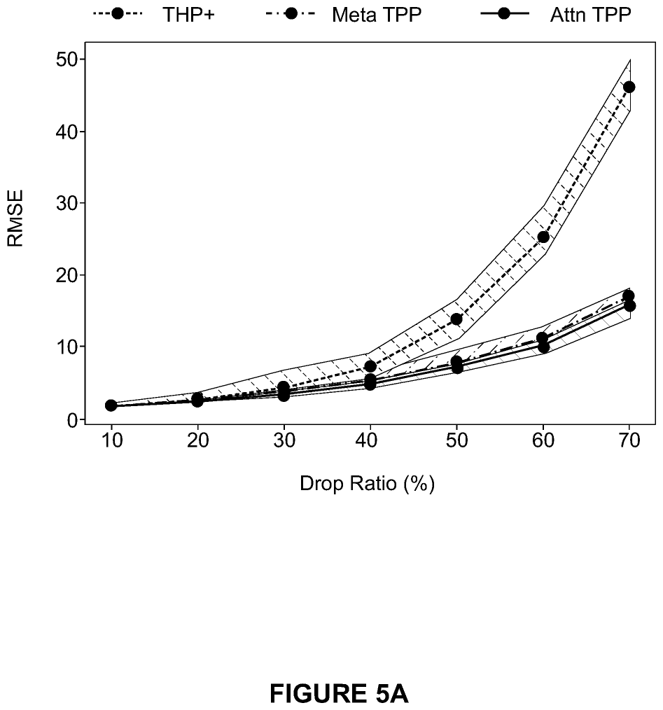

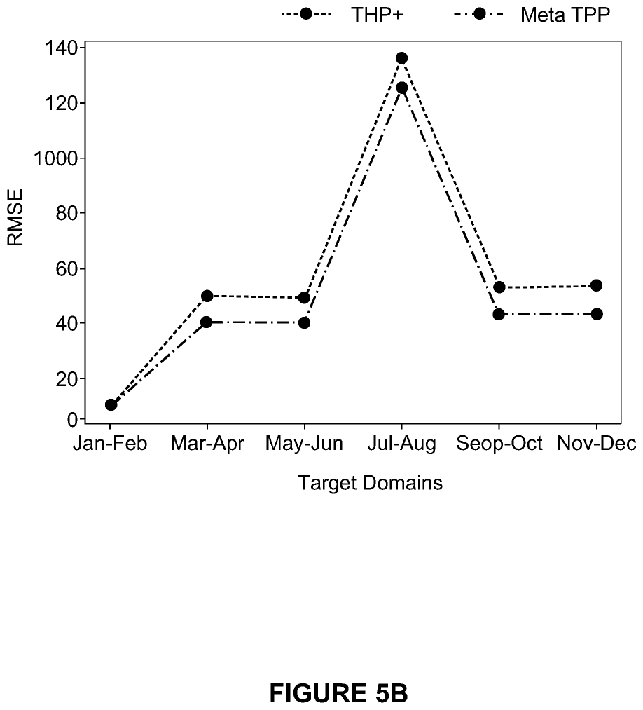

Grid-searching was carried out on every combination of dataset and method for learning rate ∈{0.01, 0.001, 0.0001, 0.00001} and weight decay E {0.01, 0.001, 0.0001, 0.00001} for fair comparison. Bootstrapping for 200 times on test sets was used to obtain the mean and standard deviation (in parentheses) for the metrics in FIG. 5A (showing imputation with different drop rates) and Tables 2 to 3 following Yang et al. (2022). All the other hyperparameters are fixed throughout the experiments.

A feature dimension of 96, 72, and 64 was used for the intensity-free (Shchur et al., 2020), neural flow (Biloš et al., 2021), and THP⁺, respectively, as the numbers of parameters fall in the range of 50K and 60K with those dimensions.

For the Meta TPP, 64 is used for the dimension of the global latent variable z, and 32 samples are used to approximate the ELBO for variational inference. As the variance of variational inference is generally low, 32 samples are enough to have stable results. In inference, the sample size is increased to 256 to have more accurate approximation. For the Attentive TPP, 1-layer self-attention is used for the cross-attention path, and the local history window size is fixed at 20.

For training, a batch size of 16 is used throughout all the models, and optimized with an adaptive moment estimation (Adam) optimizer for a grid search for learning rate and weight decay as described above.

### Experimental Results

The Attentive TPP approach shown in FIG. 3 was compared with state-of-the-art supervised TPP methods on the four (4) benchmark datasets described above. Additional experiments investigate how Attentive TPP captures periodic patterns, and how Attentive TPP can be used to impute missing events in noisy sequences. Finally, robustness under distribution drift is considered.

Comparison with State-of-the-Art Methods

Table 2 below summarizes the comparison of Attentive TPP with state-of-the-art baselines-intensity-free (Shchur et al., 2020), neural flow (Biloš et al., 2021), and THP⁺ (Zuo et al., 2020) on the Stack Overflow, Mooc, Reddit, and Wiki benchmark datasets. Note that neural flow results on Uber, NYC Taxi and Stack Overflow datasets are not included in the table because the official implementation runs into “Not a Number” (NaN) values for long event sequences in the inversion step. THP⁺ generally performs better than the intensity-free and neural flow baselines. Attentive TPP further improves over THP⁺ on all datasets and metrics except for mark accuracy on Mooc and Wiki.

TABLE 2
Comparison of Attentive TPP to the state-of-the-art methods on a bootstrapped test sets.

| | Stack Overflow | | | Mooc | | | Reddit | | | Wiki | | |
|---|---|---|---|---|---|---|---|---|---|---|---|---|
| Methods | RMSE | NLL | Acc | RMSE | NLL | Acc | RMSE | NLL | Acc | RMSE | NLL | Acc |
| Intensity-free | 3.64 | 3.66 | 0.43 | 0.31 | 0.94 | 0.40 | 0.18 | 1.09 | 0.60 | 0.60 | 7.76 | 0.26 |
| | (0.26) | (0.02) | (0.005) | (0.006) | (0.03) | (0.004) | (0.006) | (0.04) | (0.008) | (0.05) | (0.40) | (0.03) |
| Neutral flow | — | — | — | 0.47 | 0.43 | 0.30 | 0.32 | 1.30 | 0.60 | 0.56 | 11.55 | 0.05 |
| | — | — | — | (0.006) | (0.02) | (0.04) | (0.04) | (0.33) | (0.07) | (0.05) | (2.22) | (0.01) |
| THP⁺ | 1.68 | 3.28 | 0.46 | 0.18 | 0.13 | 0.38 | 0.26 | 1.20 | 0.60 | 0.17 | 6.25 | 0.23 |
| | (0.16) | (0.02) | (0.004) | (0.005) | (0.02) | (0.004) | (0.005) | (0.04) | (0.007) | (0.02) | (0.39) | (0.03) |
| Attentive TPP | 1.15 | 2.64 | 0.46 | 0.16 | −0.72 | 0.36 | 0.11 | 0.03 | 0.60 | 0.15 | 6.25 | 0.25 |
| | (0.02) | (0.02) | (0.004) | (0.004) | (0.02) | (0.003) | (0.002) | (0.04) | (0.007) | (0.01) | (0.38) | (0.03) |

### Applications

Applications of the Meta TPP approach and the Attentive TPP approach as described herein include handling of imputation and distribution drift.

### Imputation

Imputation is the replacement of missing values in a dataset with substituted values. The robustness of the Meta TPP approach and the Attentive TPP approach to noise was evaluated by randomly dropping events, simulating partial observability in a noisy environment, and measuring imputation performance. For the experiment, n percent of all the event times were dropped, drawn independently at random per sequence on the Sinusoidal dataset. In FIG. 5A, the bootstrapped imputation performance of THP⁺, Meta TPP, and Attentive TPP are shown in terms of RMSE. As the drop ratio increases, RMSE increases for all three models but the gap exponentially increases. Given that the performance gap between three models on ‘next event’ predictions is not as large (mean RMSE-THP⁺: 1.72, Meta TPP: 1.49, Attentive TPP: 1.45), the results shown in FIG. 5A imply that the Meta and Attentive TPP are significantly more robust to the noise coming from partial observability.

### Distribution Drift

Distribution drift occurs when the distribution observed during training becomes misaligned with the distribution during deployment due to changes in the underlying patterns over time. This is a common deployment challenge in real-world systems. FIG. 5B shows how THP⁺ and Meta TPP models trained on the January-February data of the NYC Taxi dataset generalize to subsequent months. Both models show a decrease in performance, suggesting the presence of non-stationary or seasonal patterns in the data that are not captured in the training months; however, the Meta TPP approach is comparatively more robust across all out-of-domain settings. Although the Attentive TPP approach generally performs better than Meta TPP in the conventional experimental setting, this is not the case for distribution drifts. Without being limited by theory, this may be because the cross-attention is designed to alleviate the underfitting problem, which may result in reduced robustness to distribution drift. Therefore, in applications where distribution drift is anticipated or known to be present, Meta TPP is preferred to Attentive TPP.

### Periodic Patterns

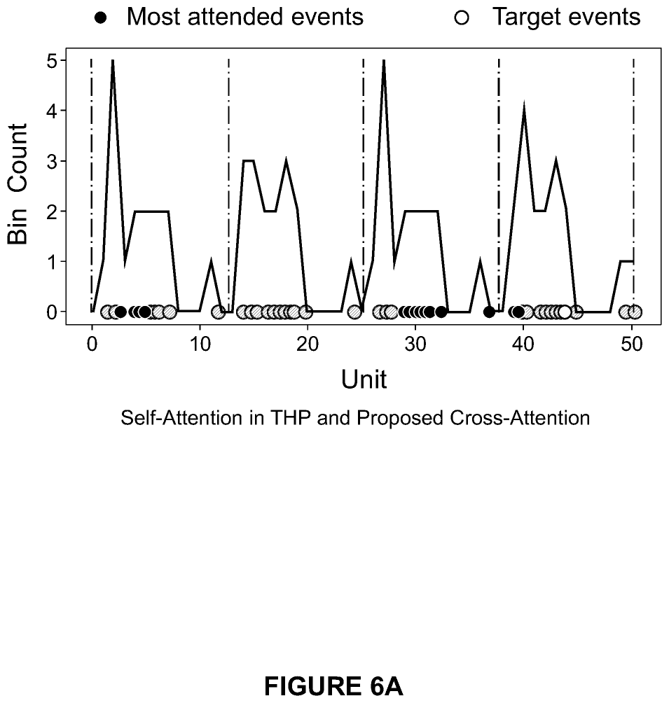

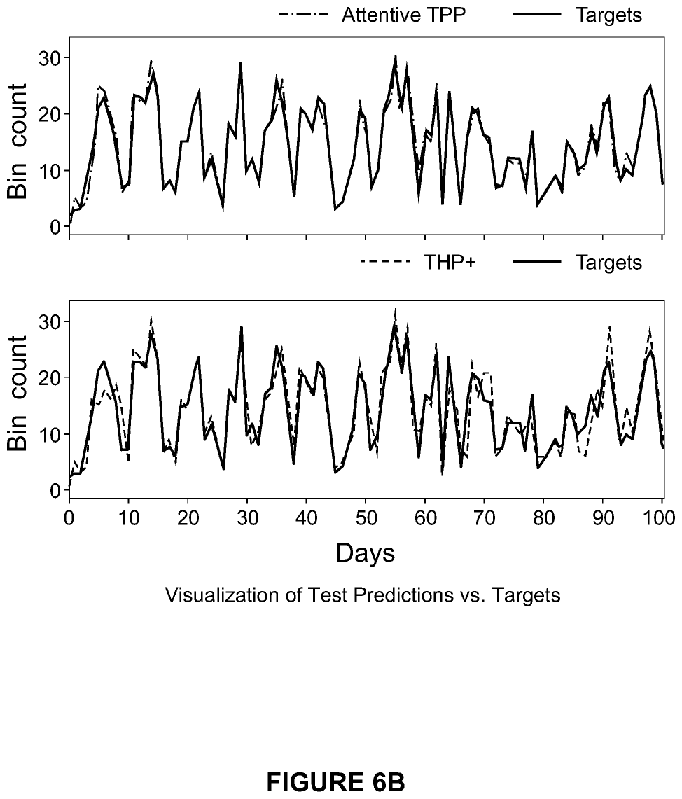

The cross-attention module is designed to capture periodic patterns by matching the local history of the current event to the local histories of the previous event times, in addition to alleviating the underfitting problem. To validate the effectiveness of the cross-attention, experiments were performed using the datasets with strong periodicity-Sinusoidal, Uber, and NYC Taxi. As shown in Table 3 below, Attentive TPP generally outperforms the state-of-the-art methods, except for RMSE on Sinusoidal. To investigate the behavior of the cross-attention, an example is provided in FIG. 6A where 15 (out of 64) of the most attended local history indices are highlighted (solid black) to predict the target event (solid white) in a sequence from Sinusoidal. The vertical dot-dash-dot lines represent the start and end of periods. The attention refers to the local histories with similar patterns more than the recent ones.

TABLE 3
Experiment results on bootstrapped test sets with strong periodic patterns.

| | Sinusoidal | | Uber | | NYC Taxi | | | |
|---|---|---|---|---|---|---|---|---|
| Methods | RMSE | NLL | RMSE | NLL | RMSE | | NLL | |
| Intensity-free | 1.29 (0.08) | 0.88 (0.02) | 51.23 (2.89) | 4.46 (0.02) | 46.59 | (26.16) | 2.06 | (0.07) |
| Neutral flow | 1.13 (0.07) | 0.99 (0.02) | — | — | — | | — | |
| THP⁺ | 1.72 (0.10) | 0.84 (0.02) | 90.25 (4.53) | 3.63 (0.03) | 10.31 | (0.47) | 2.00 | (0.01) |
| Attentive TPP | 1.45 (0.11) | 0.66 (0.02) | 22.11 (1.94) | 2.89 (0.04) | 8.92 | (0.42) | 2.00 | (0.009) |

### Ablation Studies

### Comparison of the Approaches

In Table 4 below, the approaches described herein (Conditional Meta TPP, Meta TPP, cross-attention without the use of a latent variable (see FIG. 3A), and Attentive TPP are compared on the Reddit and Uber datasets. The results show that both cross-attention and latent variable path generally help to improve the performance. When they are combined (resulting in the Attentive TPP model), this generally performs the best in terms of both RMSE and NLL.

TABLE 4
Comparison of the variants of Meta TPPs.

| | | Reddit | | | Uber | |
|---|---|---|---|---|---|---|
| Attention | Latent | RMSE | NLL | Acc | RMSE | NLL |
| X | X | 0.16 | 0.92 | 0.59 | 63.71 | 3.68 |
| X | ✓ | 0.13 | −0.39 | 0.61 | 63.35 | 3.25 |
| ✓ | X | 0.12 | 0.29 | 0.61 | 47.91 | 3.72 |
| ✓ | ✓ | 0.12 | 0.07 | 0.60 | 21.87 | 2.98 |

### Different Model Sizes

Both latent path and cross-attention components introduce additional learnable parameters (for the Reddit dataset with 984 classes, THP⁺: 113K, Meta TPP: 126K, and Attentive TPP: 209K parameters). An ablation study with a varying number of model parameters for the THP⁺ baseline was conducted to validate that the performance improvement does not come from the increased number of model parameters. Table 5 below shows the result of increasing the number of model parameters for THP⁺ on Reddit along with the result of the Attentive TPP approach. The results show that the larger model does not necessarily help to improve the performance: as the number of parameters increases, NLL sometimes improves but it may hurt RMSE as shown in Table 5. The significant improvement in performance of the Attentive TPP approach shows the importance of providing an effective inductive bias.

TABLE 5
Comparison of diff. model size.

| | | Reddit | | |
|---|---|---|---|---|
| Methods | # Params | RMSE | NLL | Acc |
| THP⁺ | 113K | 0.26 | 1.19 | 0.60 |
| | 170K | 0.29 | 0.79 | 0.59 |
| | 226K | 0.28 | 1.44 | 0.57 |
| AttnTPP | 222K | 0.12 | 0.07 | 0.60 |

### Parameter Sharing

The encoder of the latent path (or global feature path) (e.g. prediction encoder 302, 302A) and attention path (e.g. attention encoder 334, 334A) may be separated to provide different features. However, this can significantly increase computational overhead, and for this reason, in one embodiment of the Attentive TPP approach the weights for the encoders are shared (e.g. weight sharing 340, 340A in FIGS. 3 and 3A). As an ablation study, the performance with and without weight sharing was evaluated for the encoders of the Attentive TPP model on the Stack Overflow dataset. Although the number of parameters of ‘with sharing’ is 50% less than ‘without sharing’ (‘without sharing’: 86K vs. ‘with sharing’: 136K), ‘with sharing’ performs better than ‘without sharing’ (RMSE/NLL-‘without sharing’: 1.08/3.20 vs. ‘with sharing’: 1.03/2.81).

### Visualization of Event Time Predictions

In TPP literature, the evaluation relies only on the RMSE and NLL metrics. It is, however, often hard to measure how practically useful a trained TPP model is. To qualitatively evaluate TPP models, an event time sequence may be converted into a time series sequence by counting the number of event times falling into each bin. FIG. 6B shows the results (in the evaluation performed each bin is a day), illustrating how close overall predictions of the Attentive TPP (dot-dash-dot line) and THP⁺ (dashed line) are to the ground truth event times (solid line). In FIG. 6B, it can be seen see that the Attentive TPP model's predictions closely align with the targets whereas the predictions of the THP⁺ are off at some regions. Note that as the y-axis represents bin counts, even a small misalignment from the ground truth implies large values in terms of RMSE.

### Global Latent Feature

In Table 6 below, the THP⁺ baseline and Meta TPP are compared on the Sinusoidal, Uber and NYC Taxi datasets to demonstrate the effectiveness of the global latent feature z. The decoder of the Meta TPP model takes the global latent feature z (from the permutation invariance constraint) as an input, in addition to the target input feature r_l that the decoder of the THP⁺ baseline takes as input. The result shows that the global latent feature z generally helps to improve both RMSE and NLL performance.

TABLE 6
Comparison between THP⁺ baseline and Meta TPP.

| | Sinusoidal | | Uber | | NYC Taxi | |
|---|---|---|---|---|---|---|
| Methods | RMSE | NLL | RMSE | NLL | RMSE | NLL |
| THP⁺ | 1.72 | 0.84 | 90.25 | 3.63 | 10.31 | 2.00 |
| Meta TPP | 1.48 | 0.61 | 63.35 | 3.25 | 10.04 | 2.33 |

### Comparison of Variational Inference to Monte Carlo Approximation

Although MC approximation outperforms VI for the proposed Meta TPP, this is not the case for the Attentive TPP as shown in Table 7 below:

TABLE 7
Comparison of the variants of Meta TPPs.

| | Latent | | Reddit | | | Uber | | NYC Taxi | |
|---|---|---|---|---|---|---|---|---|---|
| Attention | VI | MC | RMSE | NLL | ACC | RMSE | NLL | RMSE | NLL |
| X | ✓ | X | 0.13 | −0.39 | 0.61 | 63.35 | 3.25 | 10.04 | 2.33 |
| X | X | ✓ | 0.11 | 0.16 | 0.61 | 37.12 | 3.22 | 10.15 | 2.00 |
| ✓ | ✓ | X | 0.11 | 0.03 | 0.60 | 21.87 | 2.98 | 8.92 | 2.00 |
| ✓ | X | ✓ | 0.13 | −0.05 | 0.60 | 22.38 | 3.18 | 9.10 | 2.01 |

Without being limited by theory, MC approximation may be better at sharing a role with the cross-attention path when compared to the VI approximation. More specifically, cross-attention forces a model to have similar features for repeating local history patterns. As it focuses on extracting features from the previous history, which is similar to what z˜p_{θ}(z| [symbol] ₗ) contains, the latent and attentive path share a role in MC approximation. On the other hand, as the model is trained on the global latent feature z˜p_{θ}(z| [symbol] _{L}) in VI, without focusing too much on the previous history due to the cross-attention, it may be able to utilize more diverse features.

### Comparison to Naïve Baseline

Sometimes naïve baselines can be stronger baselines than more sophisticated ones. To investigate if that is the case for TPPs, a naïve baseline was implemented. The naïve baseline makes predictions based on median inter-event interval: \hat{τ}_l+1=t_l+Δt_median, l where Δt_median, l is a median of the inter-event interval up to l-th event. Boostrapping for 200 times on the test set was used to obtain the mean of RMSE metrics as with the other methods (NLLs are not available for the naïve baseline). As can be seen in Table 8 below, even though the performance of the naïve baseline is surprisingly good for some cases (e.g. better than the intensity-free approach for the Wiki and NYC Taxi datasets), the Attentive TPP approach substantially outperformed the naïve baseline on all of the tested datasets.

TABLE 8
Comparison of Naïve baseline and other methods.

| | Stack | | | | Sinu- | | NYC |
|---|---|---|---|---|---|---|---|
| Methods | Overflow | Mooc | Reddit | Wiki | soidal | Uber | Taxi |
| Naïve | 161.21 | 0.79 | 0.38 | 0.21 | 4.61 | 107.91 | 24.58 |
| baseline | | | | | | | |
| Intensity-free | 3.64 | 0.31 | 0.18 | 0.60 | 1.29 | 51.23 | 46.59 |
| Neural flow | — | 0.47 | 0.32 | 0.56 | 1.13 | — | — |
| THP⁺ | 1.68 | 0.18 | 0.26 | 0.17 | 1.72 | 90.25 | 10.31 |
| Attentive | 1.15 | 0.16 | 0.11 | 0.15 | 1.45 | 22.11 | 8.92 |
| TPP | | | | | | | |

### Effect of Model Size

Further evidence (in addition to the ablation studies detailed above) that the improvement in performance does not come from the size of a model is provided in the tables below:

TABLE 9
Comparison of different model size on periodic datasets.

| | | Sinusoidal | | Uber | | NYC Taxi | | | |
|---|---|---|---|---|---|---|---|---|---|
| Methods | # Params | RMSE | NLL | RMSE | NLL | RMSE | | NLL | |
| THP⁺ | 50K | 1.72 (0.10) | 0.84 (0.02) | 90.25 (4.53) | 3.63 (0.03) | 10.31 | (0.47) | 2.00 | (0.01) |
| | 100K | 1.84 (0.13) | 1.04 (0.02) | 82.69 (4.56) | 3.34 (0.03) | 10.16 | (0.47) | 1.92 | (0.01) |
| Attentive TPP | 96K | 1.45 (0.11) | 0.66 (0.02) | 22.11 (1.94) | 2.89 (0.04) | 8.92 | (0.42) | 2.00 | (0.009) |

TABLE 10
Comparison of different model size on the Stack Overflow dataset.

| | | Stack Overflow | | |
|---|---|---|---|---|
| Methods | # Params | RMSE | NLL | Acc |
| THP⁺ | 52K | 1.68 (0.16) | 3.28 (0.02) | 0.46 (0.004) |
| | 103K | 1.63 (0.06) | 2.82 (0.03) | 0.46 (0.004) |
| Attentive TPP | 99K | 1.15 (0.02) | 2.64 (0.02) | 0.46 (0.004) |

TABLE 11
Comparison of different model size on the Mooc dataset.

| | | Mooc | | |
|---|---|---|---|---|
| Methods | # Params | RMSE | NLL | Acc |
| THP⁺ | 56K | 0.18 (0.005) | 0.13 (0.02) | 0.38 (0.004) |
| | 113K | 0.22 (0.007) | 0.05 (0.03) | 0.39 (0.004) |
| Attentive TPP | 108K | 0.16 (0.004) | −0.72 (0.02) | 0.36 (0.003) |

TABLE 12
Comparison of different model size on the Wiki dataset.

| | | Wiki | | |
|---|---|---|---|---|
| Methods | # Params | RMSE | NLL | Acc |
| THP⁺ | 577K | 0.17 (0.02) | 6.25 (0.39) | 0.23 (0.03) |
| | 1153K | 0.16 (0.01) | 6.47 (0.40) | 0.21 (0.02) |
| Attentive TPP | 1149K | 0.15 (0.01) | 6.25 (0.38) | 0.25 (0.03) |

In the tables above, it can be seen that in many cases, smaller models perform better than larger models, namely on Sinusoidal, Mooc, and Wiki. Although it is sometimes true that larger models perform better than their smaller counterparts, they are still significantly worse than the Attentive TPP approach described herein. Note that exactly the same grid search for hyperparameter tuning was conducted for the larger models. The results empirically demonstrate that the improvement does not necessarily come from the size of a model but from appropriate inductive biases.

Without being limited by theory, the RMSE, NLL, and accuracy on test sets are considered to be good metrics to compare the generalization performance of different models. Since the Attentive TPP approach described herein outperforms all the baselines, the experimental results outlined above empirically demonstrate the robustness of the Attentive TPP approach in terms of generalization.

### Technological Improvement and Specific Technological Application

As can be seen from the above description, the Conditional Meta TPP, Meta TPP and Attentive TPP (with either global feature or global latent variable) approaches described herein represent significantly more than merely using categories to organize, store and transmit information and organizing information through mathematical correlations. The Conditional Meta TPP, Meta TPP and Attentive TPP approaches described herein are confined to machine learning, and more particularly to machine learning in the context of TPP. The Conditional Meta TPP, Meta TPP and Attentive TPP approaches are each in fact an improvement to machine learning in the context of TPP, as they handle TPP prediction in a meta learning framework. The results outperform strong state-of-the-art baselines on several event sequence datasets, effectively capture periodic patterns, and increase robustness to noise and distribution drift.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

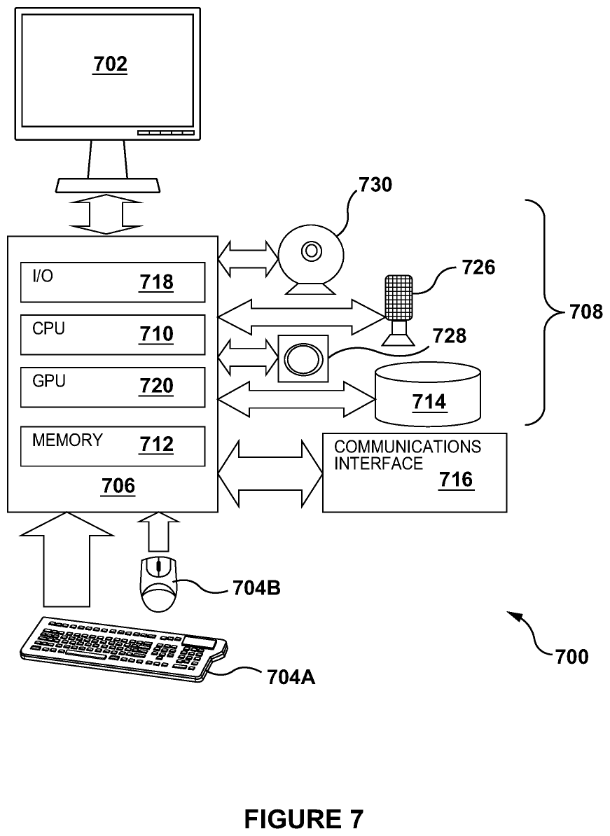

An illustrative computer system in respect of which the technology herein described may be implemented is presented as a block diagram in FIG. 7. The illustrative computer system is denoted generally by reference numeral 700 and includes a display 702, input devices in the form of keyboard 704A and pointing device 704B, computer 706 and external devices 708. While pointing device 704B is depicted as a mouse, it will be appreciated that other types of pointing device, or a touch screen, may also be used.

The computer 706 may contain one or more processors or microprocessors, such as a central processing unit (CPU) 710. The CPU 710 performs arithmetic calculations and control functions to execute software stored in an internal memory 712, preferably random access memory (RAM) and/or read only memory (ROM), and possibly additional memory 714. The additional memory 714 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 714 may be physically internal to the computer 706, or external as shown in FIG. 7, or both.

The computer system 700 may also include other similar means for allowing computer programs or other instructions to be loaded. Such means can include, for example, a communications interface 716 which allows software and data to be transferred between the computer system 700 and external systems and networks. Examples of communications interface 716 can include a modem, a network interface such as an Ethernet card, a wireless communication interface, or a serial or parallel communications port. Software and data transferred via communications interface 716 are in the form of signals which can be electronic, acoustic, electromagnetic, optical or other signals capable of being received by communications interface 716. Multiple interfaces, of course, can be provided on a single computer system 700.

Input and output to and from the computer 706 is administered by the input/output (I/O) interface 718. This I/O interface 718 administers control of the display 702, keyboard 704A, external devices 708 and other such components of the computer system 700. The computer 706 also includes a graphical processing unit (GPU) 720. The latter may also be used for computational purposes as an adjunct to, or instead of, the (CPU) 710, for mathematical calculations.

The external devices 708 include a microphone 726, a speaker 728 and a camera 730. Although shown as external devices, they may alternatively be built in as part of the hardware of the computer system 700.

The various components of the computer system 700 are coupled to one another either directly or by coupling to suitable buses.

The terms “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 712 of the computer 706, or on a computer usable or computer readable medium external to the computer 706, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

The reader is also respectfully referred to the following publicly available repositories, also incorporated by reference herein: https://github.com/shchur/ifl-tpp and https://github.com/mbilos/neural-flows-experiments.

### REFERENCES

None of the documents cited herein is admitted to be prior art (regardless of whether or not the document is explicitly denied as such). The following list of references is provided without prejudice for convenience only, and without admission that any of the references listed herein is citable as prior art.
Marin Biloš, Johanna Sommer, Syama Sundar Rangapuram, Tim Januschowski, and Stephan Günnemann. Neural flows: Efficient alternative to neural odes. In NeurIPS, 2021.
D. J. Daley and D. Vere-Jones. An introduction to the theory of point processes. Vol. I. Probability and its Applications (New York). Springer-Verlag, New York, second edition, 2003. ISBN 0-387-95541-0. Elementary theory and methods.
Nan Du, Hanjun Dai, Rakshit Trivedi, Utkarsh Upadhyay, Manuel Gomez-Rodriguez, and Le Song. Recurrent marked temporal point processes: Embedding event history to vector. In SIGKDD, 2016.
Yann Dubois, Jonathan Gordon, and Andrew YK Foong. Neural process family. http://yanndubs.github.io/Neural-Process-Family/, September 2020.
Chelsea Finn, Pieter Abbeel, and Sergey Levine. Model-agnostic meta-learning for fast adaptation of deep networks. In ICML, pp. 1126-1135. PMLR, 2017.
Chelsea Finn, Kelvin Xu, and Sergey Levine. Probabilistic model-agnostic meta-learning. In NeurIPS, 2018.
Andrew Y K Foong, Wessel P Bruinsma, Jonathan Gordon, Yann Dubois, James Requeima, and Richard E Turner. Meta-learning stationary stochastic process prediction with convolutional neural processes. In NeurIPS, 2020.
Marta Garnelo, Dan Rosenbaum, Christopher Maddison, Tiago Ramalho, David Saxton, Murray Shanahan, Yee Whye Teh, Danilo Rezende, and SM Ali Eslami. Conditional neural processes. In ICML, 2018a.
Marta Garnelo, Jonathan Schwarz, Dan Rosenbaum, Fabio Viola, Danilo J Rezende, S M Eslami, and Yee Whye Teh. Neural processes. In ICML Workshop, 2018b.
Jonathan Gordon, Wessel P Bruinsma, Andrew YK Foong, James Requeima, Yann Dubois, and Richard E Turner. Convolutional conditional neural processes. In ICLR, 2020.
Erin Grant, Chelsea Finn, Sergey Levine, Trevor Darrell, and Thomas Griffiths. Recasting gradient-based meta-learning as hierarchical bayes. In ICLR, 2018.
Alan G Hawkes. Spectra of some self-exciting and mutually exciting point processes. Biometrika, 1971.
Valerie Isham and Mark Westcott. A self-correcting point process. Stochastic processes and their applications, 1979.
Hyunjik Kim, Andriy Mnih, Jonathan Schwarz, Marta Garnelo, Ali Eslami, Dan Rosenbaum, Oriol Vinyals, and Yee Whye Teh. Attentive neural processes. In ICLR, 2019.
Gregory Koch et al. Siamese neural networks for one-shot image recognition. In ICML, 2015.
Srijan Kumar, Xikun Zhang, and Jure Leskovec. Predicting dynamic embedding trajectory in temporal interaction networks. In SIGKDD, 2019.
Haitao Lin, Lirong Wu, Guojiang Zhao, Pai Liu, and Stan Z Li. Exploring generative neural temporal point process. TMLR, 2022.
Hongyuan Mei and Jason M Eisner. The neural hawkes process: A neurally self-modulating multivariate point process. In NeurIPS, 2017.
Tsendsuren Munkhdalai and Hong Yu. Meta networks. In ICML, 2017.
Tung Nguyen and Aditya Grover. Transformer neural processes: Uncertainty-aware meta learning via sequence modeling. In ICML, 2022.
Alex Nichol, Joshua Achiam, and John Schulman. On first-order meta-learning algorithms. arXiv preprint arXiv: 1803.02999, 2018.
Bernt Oksendal. Stochastic Differential Equations: an Introduction with Applications. Springer Science & Business Media, 2013.
Takahiro Omi, Kazuyuki Aihara, et al. Fully neural network based model for general temporal point processes. In NeurIPS, 2019.
Adam Santoro, Sergey Bartunov, Matthew Botvinick, Daan Wierstra, and Timothy Lillicrap. Metalearning with memory-augmented neural networks. In ICML, 2016.
Karishma Sharma, Yizhou Zhang, Emilio Ferrara, and Yan Liu. Identifying coordinated accounts on social media through hidden influence and group behaviours. In SIGKDD, 2021.
Oleksandr Shchur, Marin Biloš, and Stephan Günnemann. Intensity-free learning of temporal point processes. In ICLR, 2020.
Oleksandr Shchur, Ali Caner Türkmen, Tim Januschowski, and Stephan Günnemann. Neural temporal point processes: A review. In IJCAI, 2021.
Jake Snell, Kevin Swersky, and Richard S. Zemel. Prototypical networks for few-shot learning. In NeurIPS, 2017.
Flood Sung, Yongxin Yang, Li Zhang, Tao Xiang, Philip H S Torr, and Timothy M Hospedales. Learning to compare: Relation network for few-shot learning. In CVPR, 2018.
Ashish Vaswani, Noam Shazeer, Niki Parmar, Jakob Uszkoreit, Llion Jones, Aidan N Gomez, Łukasz Kaiser, and Illia Polosukhin. Attention is all you need. In NeurIPS, 2017.
Oriol Vinyals, Charles Blundell, Timothy Lillicrap, Daan Wierstra, et al. Matching networks for one shot learning. In NeurIPS, 2016.
Chenghao Yang, Hongyuan Mei, and Jason Eisner. Transformer embeddings of irregularly spaced events and their participants. In ICLR, 2022.
Qiang Zhang, Aldo Lipani, Omer Kirnap, and Emine Yilmaz. Self-attentive hawkes process. In ICML, 2020.
Yunhao Zhang, Junchi Yan, Xiaolu Zhang, Jun Zhou, and Xiaokang Yang. Learning mixture of neural temporal point processes for multi-dimensional event sequence clustering. In IJCAI, 2022.
Simiao Zuo, Haoming Jiang, Zichong Li, Tuo Zhao, and Hongyuan Zha. Transformer hawkes process. In ICML, 2020.

Certain currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented machine learning method for prediction for a temporal point process, the method comprising:
receiving, by at least one trained encoder, an event series comprising a plurality of discrete event times τ₁, τ₂ . . . τₗ;
outputting, by the at least one trained encoder, an encoded history of context features r₁, r₂ . . . rₗ, wherein:
the encoded history is derived from the event times; and
the encoded history is restricted to a local history window of size k, where the local history window excludes those of the event times that are more than k events ago;
generating a global feature G from the encoded history, wherein generating the global feature G is performed using a subset r₁, r₂ . . . rₗ₋₁ of the encoded history that excludes a most recent one rₗ of the context features;
providing, to a trained decoder:
a representation of the global feature G; and
the most recent one rₗ of the context features r₁, r₂ . . . rₗ;
outputting by the trained decoder, a prediction for a time τₗ₊₁ of a next event, wherein the prediction is derived from at least the representation of the global feature G and the most recent one rₗ of the context features r₁, r₂ . . . rₗ.

2. The method of claim 1, wherein the representation of the global feature G is the global feature G itself.

3. The method of claim 1, wherein the representation of the global feature G is a global latent variable z for the global feature G.

4. The method of claim 1, wherein:
the method further comprising:
applying cross-attention to the subset r₁, r₂ . . . rₗ₋₁ of the encoded history to generate an attention feature rₗ′; and
providing the attention feature rₗ′ to the trained decoder;
wherein the prediction is further derived from the attention feature rₗ′.

5. The method of claim 4, wherein the representation of the global feature G is a global latent variable z for the global feature G.

6. The method of claim 4, wherein the at least one encoder is a single encoder.

7. The method of claim 4, wherein the at least one encoder is a first encoder and a second encoder.

8. The method of claim 7, wherein the first encoder and the second encoder are different encoders.

9. The method of claim 8, wherein the first encoder and the second encoder share at least some model parameters.

10. The method of claim 7, wherein the first encoder and the second encoder are duplicate encoders.

11. The method of claim 1, wherein the global feature G is a permutation-invariant operation incorporating all members of the subset r₁, r₂ . . . rₗ₋₁ of the encoded history.

12. The method of claim 1, further comprising, prior to receiving the event series at the trained encoder:
building the at least one trained encoder; and
building the trained decoder.

13. A data processing system comprising memory and at least one processor, wherein the memory contains instructions which, when implemented by the at least one processor, cause the data processing system to implement a machine learning method for prediction for a temporal point process, the method comprising:
receiving, by at least one trained encoder, an event series comprising a plurality of discrete event times τ₁, τ₂ . . . τₗ;
outputting, by the at least one trained encoder, an encoded history of context features r₁, r₂ . . . rₗ, wherein:
the encoded history is derived from the event times; and
the encoded history is restricted to a local history window of size k, where the local history window excludes those of the event times that are more than k events ago;
generating a global feature G from the encoded history, wherein generating the global feature G is performed using a subset r₁, r₂ . . . rₗ₋₁ of the encoded history that excludes a most recent one rₗ of the context features;
providing, to a trained decoder:
a representation of the global feature G; and
the most recent one rₗ of the context features r₁, r₂ . . . rₗ;
outputting by the trained decoder, a prediction for a time σₗ₊₁ of a next event, wherein the prediction is derived from at least the representation of the global feature G and the most recent one rₗ of the context features r₁, r₂ . . . rₗ.

14. The data processing system of claim 13, wherein the representation of the global feature G is the global feature G itself.

15. The data processing system of claim 13, wherein the representation of the global feature G is a global latent variable z for the global feature G.

16. The data processing system of claim 13, wherein the method further comprises:
applying cross-attention to the subset r₁, r₂ . . . rₗ₋₁ of the encoded history to generate an attention feature rₗ′; and
providing the attention feature rₗ′ to the trained decoder;
wherein the prediction is further derived from the attention feature rₗ′.

17. The data processing system of claim 16, wherein the representation of the global feature G is a global latent variable z for the global feature G.

18. The data processing system of claim 16, wherein the at least one encoder is a single encoder.

19. The data processing system of claim 16, wherein the at least one encoder is a first encoder and a second encoder.

20. The data processing system of claim 19, wherein the first encoder and the second encoder are different encoders.

21. The data processing system of claim 20, wherein the first encoder and the second encoder share at least some model parameters.

22. The data processing system of claim 19, wherein the first encoder and the second encoder are duplicate encoders.

23. The data processing system of claim 13, wherein the global feature G is a permutation-invariant operation incorporating all members of the subset r₁, r₂ . . . rₗ₋₁ of the encoded history.

24. A computer program product comprising at least one tangible, non-transitory computer-readable medium embodying instructions which, when executed by a data processing system, cause the data processing system to implement a machine learning method for prediction for a temporal point process, the method comprising:
receiving, by at least one trained encoder, an event series comprising a plurality of discrete event times τ₁, τ₂ . . . τₗ;
outputting, by the at least one trained encoder, an encoded history of context features r₁, r₂ . . . rₗ, wherein:
the encoded history is derived from the event times; and
the encoded history is restricted to a local history window of size k, where the local history window excludes those of the event times that are more than k events ago;
generating a global feature G from the encoded history, wherein generating the global feature G is performed using a subset r₁, r₂ . . . rₗ₋₁ of the encoded history that excludes a most recent one rₗ of the context features;
providing, to a trained decoder:
a representation of the global feature G; and
the most recent one n of the context features r₁, r₂ . . . rₗ;
outputting by the trained decoder, a prediction for a time τₗ₊₁ of a next event, wherein the prediction is derived from at least the representation of the global feature G and the most recent one rₗ of the context features r₁, r₂ . . . rₗ.

25. The method of claim 24, wherein the representation of the global feature G is the global feature G itself.

26. The method of claim 24, wherein the representation of the global feature G is a global latent variable z for the global feature G.

27. The method of claim 24, wherein:
the method further comprising:
applying cross-attention to the subset r₁, r₂ . . . rₗ₋₁ of the encoded history to generate an attention feature rₗ′; and
providing the attention feature rₗ′ to the trained decoder;
wherein the prediction is further derived from the attention feature rₗ′.

28. The method of claim 27, wherein the representation of the global feature G is a global latent variable z for the global feature G.

29. The method of claim 27, wherein the at least one encoder is a single encoder.

30. The method of claim 27, wherein the at least one encoder is a first encoder and a second encoder.

31. The method of claim 30, wherein the first encoder and the second encoder are different encoders.

32. The method of claim 31, wherein the first encoder and the second encoder share at least some model parameters.

33. The method of claim 30, wherein the first encoder and the second encoder are duplicate encoders.

34. The method of claim 24, wherein the global feature G is a permutation-invariant operation incorporating all members of the subset r₁, r₂ . . . rₗ₋₁ of the encoded history.
